(19) United States
(12) Patent Application Publication
(10) Pub. No.: US 2010/0204980 A1
(43) Pub. Date: Aug. 12, 2010

(54) Real-time translation system with multimedia display function and method thereof

(75) Inventors: Chaucer Chiu, Taipei (TW); Huabei Zhao, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,850

(22) Filed: Feb. 6, 2009

(51) Int. Cl. G06F 17/28

(52) U.S. Cl. 704/7

(57) ABSTRACT

A real-time translation system with a multimedia display function and a method thereof are provided for solving the problem that a word meaning cannot be understood quickly, in which an explanation of a word is displayed in real time through a floating block, and meanwhile an image and an audio/video are played correspondingly, thereby achieving a technical effect of enhancing the translation display variety.

### BACKGROUND OF THE INVENTION

1. Field of Invention

The present invention relates to a real-time translation system with a multimedia display function and a method thereof, which provide multimedia data, so as to be helpful for making demonstrations.

2. Related Art

In recent years, along with the popularization of computers and the vigorous development of Internet, documents in foreign languages have circulated widely. However, as for non-mother-tongue users, documents in foreign languages have created considerable reading troubles. Therefore, translation software for translating the documents in foreign languages emerges accordingly.

Generally, the translation software can convert a foreign word input by a user to a word in a mother tongue primarily. However, although it is the mother tongue of the user, he/she may not be able to understand clearly the true meaning of the translated word, and as a result, misunderstandings often occur. For example, after the word “disc” and the word “disk” are translated into Chinese, it cannot figure out the difference between the two words only based on the Chinese translation, for example, [symbol] Therefore, some manufacturers propose the technology of additionally displaying a corresponding explanation text for further demonstrating the meaning of the word.

However, as for human beings, there is a great gap between the efficiency for reading texts and that for reading images. Currently, many experimental data show that, the efficiency and understanding ability of receiving images and audio/videos for human beings are much more excellent than that of reading texts. Therefore, the problem that a user cannot understand a word meaning quickly still exists when the word's meaning is displayed merely with texts.

To sum up, the problem that it cannot understand a word meaning quickly has existed in the prior art for a long time. Therefore, it is necessary to present an improved technical means to solve such a problem.

### SUMMARY OF THE INVENTION

In view of the problem in the prior art, the present invention is directed to a real-time translation system with a multimedia display function and a method thereof.

The real-time translation system with a multimedia display function provided in the present invention includes a translation database, a detect module, a retrieve module, a translate module, and an audio/video module. The translation database is adapted to store translation vocabularies, in which the translation vocabularies correspond to audio/visual data respectively. The detect module is adapted to detect continuously a retention time of a cursor, and record cursor coordinates when the retention time meets a time condition requirement. The retrieve module is adapted to retrieve an input vocabulary according to the cursor coordinates. The translate module is adapted to compare the input vocabulary with the translation vocabularies, and load a translation vocabulary and a corresponding audio/visual data when the input vocabulary and the translation vocabulary are consistent with each other through comparison. The audio/video module is adapted to display or play the loaded translation vocabulary and the audio/visual data through a floating block.

The real-time translation method with a multimedia display function provided in the present invention includes the following steps: establishing translation vocabularies, in which the translation vocabularies correspond to audio/visual data respectively; detecting continuously a retention time of a cursor, and recording cursor coordinates when the retention time meets a time condition requirement; retrieving an input vocabulary according to the cursor coordinates; comparing the input vocabulary with the translation vocabularies, and loading a translation vocabulary and a corresponding audio/visual data when the input vocabulary and the translation vocabulary are consistent with each other through comparison; and displaying or playing the loaded translation vocabulary and the audio/visual data through a floating block.

The system and method of the present invention have been described above, and the difference with the prior art lies in that, the present invention displays the explanation of a word in real time through a floating block, and meanwhile plays corresponding images and audio/videos.

With the above technical means, the present invention can achieve a technical effect of enhancing the translation display variety.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a real-time translation system with a multimedia display function according to the present invention.

FIG. 2 is a flow chart of a real-time translation method with a multimedia display function according to the present invention.

FIGS. 3 and 4 are schematic views of the present invention when being applied to perform a real-time translation.

FIG. 5 is a schematic view of a set window according to the present invention.

### DETAILED DESCRIPTION OF THE INVENTION

Those Chinese characters shown in the following descriptions or in the drawings are just mentioned for describing the embodiments and are substantially irrelevant to any technical matters.

The present invention will be apparent from the following detailed description, which proceeds with reference to the accompanying drawings, wherein the same references relate to the same elements.

Those Chinese characters shown in the drawings are just mentioned for describing the embodiments and are substantially irrelevant to any technical matters.

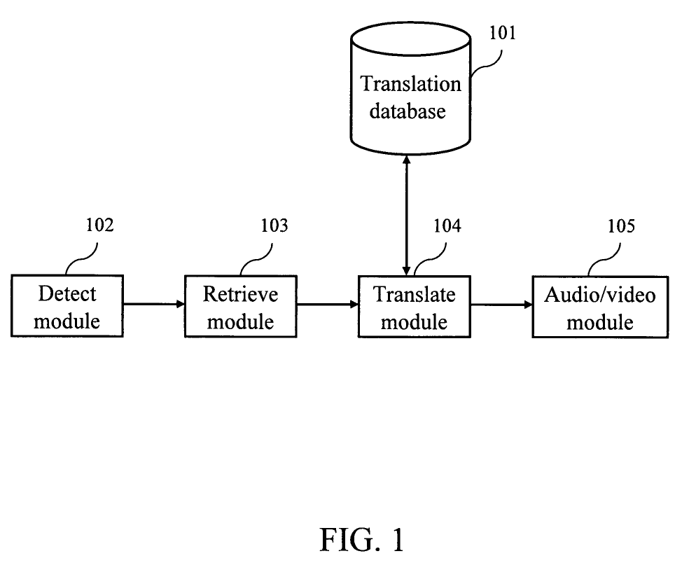

Before illustrating a real-time translation system with a multimedia display function and a method thereof according to the present invention, the nouns defined in the present invention are first explained as follows. A floating block mentioned in the present invention refers to a display block (for example, a window) that can be displayed in any position on a screen picture, and the position where it is displayed may be around a cursor, or further vary accordingly based on the changing of a cursor position, or be hidden or displayed by means of pressing a functional key. For example, such a floating block is displayed upon pressing the key “D” on a keyboard, and upon pressing the same key again, the currently displayed floating block is hidden. The system of the present invention is first illustrated below. FIG. 1 is a block diagram of a real-time translation system with a multimedia display function according to the present invention. Referring to FIG. 1, the system includes a translation database 101, a detect module 102, a retrieve module 103, a translate module 104, and an audio/video module 105. The translation database 101 is adapted to store translation vocabularies, in which the translation vocabularies include translation explanations, and correspond to audio/visual data respectively. The audio/visual data is at least one selected from a group consisting of an image, a movie and a sound. For example, the translation vocabulary is “apple”, and the included translation explanation is “n. [symbol] and the corresponding audio/visual data thereof may be a file of a picture, video, and voice about an apple, so that a user can receive the audio/visual data through vision or even through the sense of hearing, and deepen the impression and understanding ability for the translation vocabulary.

The detect module 102 is adapted to detect continuously a retention time of a cursor, and record cursor coordinates when the retention time meets a time condition requirement, in which the retention time is a time duration when the cursor stays still, and the time condition is a time length allowing to record the cursor coordinates. For example, it is assumed that the time condition is set to 5 seconds, and if the time duration when the cursor stays still (i.e., retention time) is not smaller than 5 seconds, it indicates that the time condition is met, so that the coordinates of the position where the cursor is located (i.e., the cursor coordinates) in the screen is recorded. Once the cursor is moved again, the previously recorded cursor coordinates are cleared automatically, and the retention time of the cursor is detected continuously again.

The retrieve module 103 is adapted to retrieve an input vocabulary according to the cursor coordinates. For example, when the cursor coordinates is two-dimensional coordinates, for example, it is “300” on x axis and “400” on y axis, the character or word displayed at the two-dimensional coordinates position is retrieved as the input vocabulary. In actual implementation, the word determination process may include combining a character at the cursor coordinates and a next character into a word formed by two characters, or even combining the character at the cursor coordinates with the next two characters into a word formed by three characters in the same way . . . and so on. The retrieving manner for the characters or words belongs to the prior art, so it is not described in detail here.

The translate module 104 is adapted to compare the input vocabulary with the translation vocabularies, and load a translation vocabulary and a corresponding audio/visual data when the input vocabulary and the translation vocabulary are consistent with each other through comparison. For example, when the retrieved input vocabulary is “apple”, the translate module 104 compares the input vocabulary with all the translation vocabularies in the translation database 101, and when the input vocabulary and certain translation vocabulary are consistent with each other through comparison, the translate module 104 loads the translation vocabulary and the corresponding audio/visual data, for example, an image, flash, video, or voice . . . about an apple.

The audio/video module 105 is adapted to display or play the loaded translation vocabulary and the audio/visual data through a floating block. The floating block has been illustrated above in the defined nouns, so it is no longer described in detail here. It should be specially noted that, the present invention can set the items of the audio/visual data displayed or played by the floating block through an additionally provided set window, for example, after setting to only display the image through the set window, only image is displayed on the floating block.

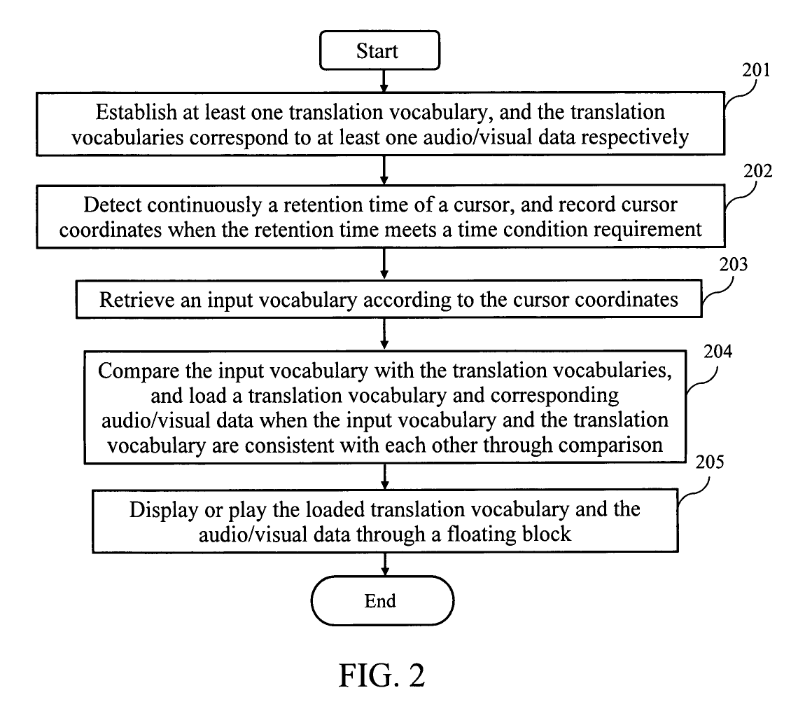

FIG. 2 is a flow chart of a real-time translation method with a multimedia display function according to the present invention. Referring to FIG. 2, the method includes the following steps: establishing translation vocabularies, in which the translation vocabularies correspond to audio/visual data respectively (Step 201); detecting continuously a retention time of a cursor, and recording cursor coordinates when the retention time meets a time condition requirement (Step 202); retrieving an input vocabulary according to the cursor coordinates (Step 203); comparing the input vocabulary with the translation vocabularies, and loading a translation vocabulary and a corresponding audio/visual data when the input vocabulary and the translation vocabulary are consistent with each other through comparison (Step 204); displaying or playing the loaded translation vocabulary and the audio/visual data through a floating block (Step 205). With the steps listed above, the word translation can be displayed in real time through a floating block when performing translation, and corresponding image and audio/video (i.e., audio/visual data) are played simultaneously, thereby achieving the effect of enhancing the translation display variety.

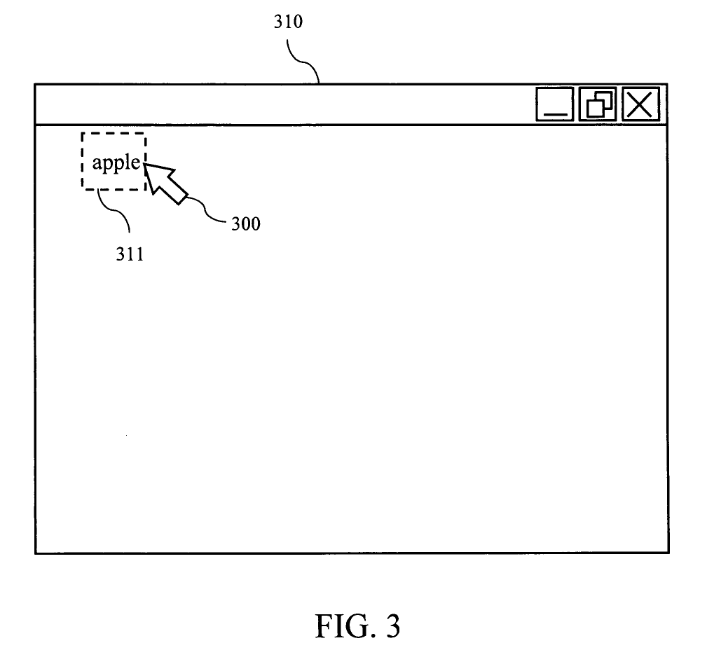

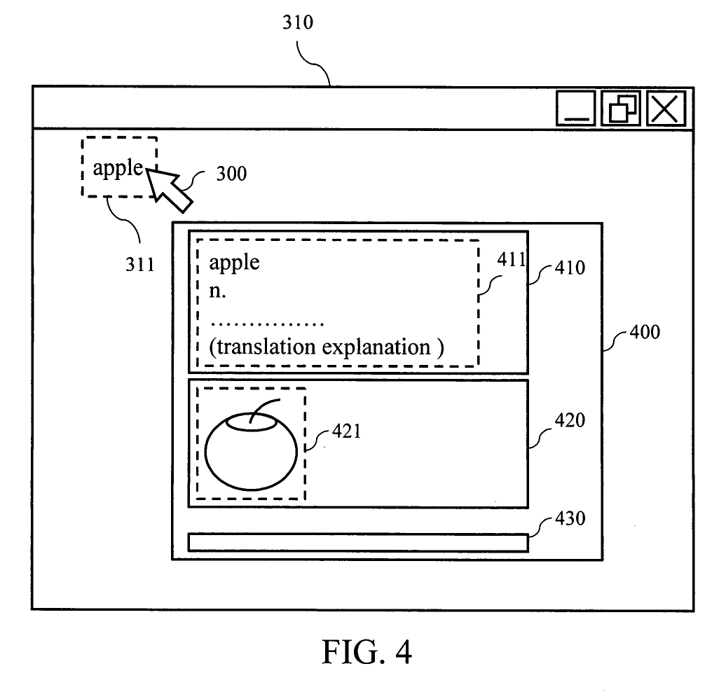

In the following, it is illustrated below through embodiments with reference to FIGS. 3-5. FIGS. 3 and 4 are schematic views of the present invention when being applied to perform a real-time translation. Referring to FIG. 3 first, after a user executes a translation software applied with the present invention, if an unknown word is found in a display window 310 (e.g., the word of “apple”), the user may move a cursor 300 to the word position and make the cursor 300 stay still. In this case, the detect module 102 detects continuously a retention time of the cursor 300, and records the current cursor coordinates when the retention time meets a time condition requirement. It is assumed that the time condition is preset to be 5 seconds, and when the retention time of the cursor 300 detected by the detect module 102 is no smaller than 5 seconds, the coordinates of the position where the current cursor 300 is located (i.e., the cursor coordinates) is recorded. In the actual implementation, the time duration may be calculated through accumulating by a timer. The present invention does not limit the way for computing the time duration, and any way of computing the time duration does not depart from the spirit of the present invention.

Then, the retrieve module 103 retrieves a character (e.g., the character of “apple”) at the position of the cursor coordinates as an input vocabulary 311 based on the recorded cursor coordinates. Since the character retrieving process belongs to the prior art, it is not described in detail here. Subsequently, the translate module 104 compares the input vocabulary 311 (e.g., “apple”) with all the translation vocabularies in the translation database 101, and loads a translation vocabulary and a corresponding audio/visual data when the input vocabulary 311 is consistent with the translation vocabulary through comparison. In this example, when the input vocabulary 311 is “apple”, the translate module 104 loads the translation vocabulary (e.g., “apple”) that is consistent with “apple” through comparison, and the audio/visual data corresponding to the translation vocabulary (e.g., files of a picture, flash, voice, and video . . . about an apple).

Then, through a floating block 400 shown in FIG. 4, the audio/video module 105 displays a loaded translation vocabulary 411 (including translation explanations) in a character display block 410, displays corresponding audio/visual data 421 (e.g., an apple picture) in an audio/video display block 420, and controls the display or play modes of the audio/video display block 420 though an audio/video control row 430. For example, when the audio/visual data 421 includes several apple pictures, different types of apple pictures can be switched to be displayed through the audio/video control row 430. When the audio/visual data 421 is a video or sound, the play mode thereof may be controlled through the audio/video control row 430, for example, replaying, stopping, pausing, fast forwarding, rewinding, and so on.

Accordingly, the floating block 400 is displayed according to the position of the cursor 300. For example, the floating block 400 is displayed within the boundary range (e.g., at the bottom right of the cursor 300) of the position of the cursor 300, as shown in FIG. 4. Alternatively, the displaying position of the floating block 400 may be varied accordingly as the position of the cursor 300 is changed, i.e., when the cursor 300 is moved from left to right, the floating block 400 also moves from left to right in the same way. Moreover, the floating block 400 may be hidden or displayed by pressing a functional key. For example, when a key “D” on a keyboard is pressed, the floating block 400 is displayed, and the currently displayed floating block 400 is hidden, when the same key “D” is pressed again. However, in actual implementation, the floating block 400 may be hidden when the cursor 300 is moved, and it is displayed or maintains a hidden state when the cursor 300 stays still.

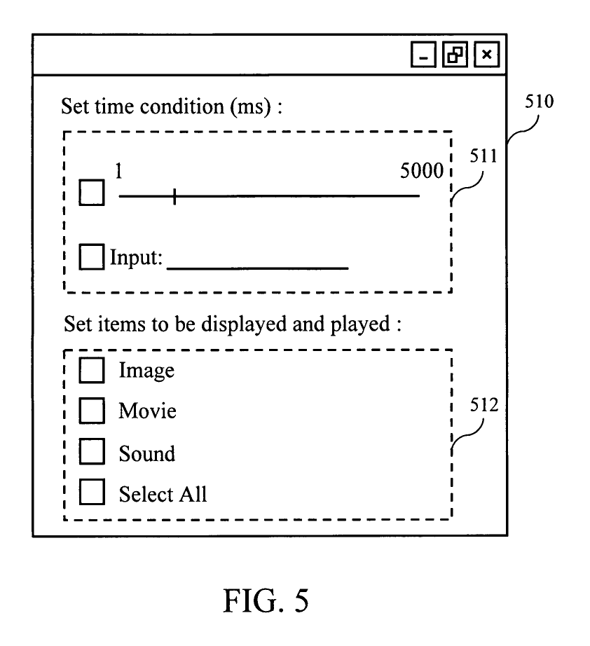

Finally, the manner of setting the time condition and the display or play items of the floating block 400 by a set window is further illustrated with reference to FIG. 5. FIG. 5 is a schematic view of a set window according to the present invention. When a user wants to set a suitable time condition according to his/her own preference, he/she can set the time condition through a time condition set block 511 in a set window 510 by means of, for example, adjusting a time axis or by inputting a value voluntarily. Moreover, when the user wants to set the items of the audio/visual data displayed or played by the floating block 400, he/she can also set the items through a display/play set block 512, for example, selecting “Image”, “Movie”, “Sound”, and “Select all” to select the items of the audio/visual data to be displayed or played.

To sum up, the difference between the present invention and the prior art lies in that, the present invention displays an explanation of a word in real time through the floating block 400, and meanwhile plays corresponding image and audio/video. With such a technical means, the translation vocabulary and the audio/visual data can be displayed simultaneously in the floating block 400, thereby solving the problem in the prior art and thus achieving a technical effect of enhancing the translation display variety.

Although the present invention is disclosed as above with preferable embodiments, it is not limited to the disclosure of the embodiments, and it will be apparent to those skilled in the art that various alternations and modifications can be made without departing from the scope or spirit of the invention. Therefore, the protection scope of the present invention depends on those defined by the scope of the following claims.

What is claimed is:

1. A real-time translation system with a multimedia display function, comprising:
a translation database, adapted to store at least one translation vocabulary, wherein the translation vocabularies correspond to at least one audio/visual data respectively;
a detect module, adapted to detect continuously a retention time of a cursor, and record cursor coordinates when the retention time thereof meets a time condition requirement;
a retrieve module, adapted to retrieve an input vocabulary according to the cursor coordinates;
a translate module, adapted to compare the input vocabulary with the translation vocabularies, and load a translation vocabulary and a corresponding audio/visual data when the input vocabulary and the translation vocabulary are consistent with each other through comparison; and
an audio/video module, adapted to display or play the loaded translation vocabulary and the audio/visual data through a floating block.

2. The real-time translation system with a multimedia display function according to claim 1, wherein the audio/visual data comprises at least one selected from an image, a movie, and a sound.

3. The real-time translation system with a multimedia display function according to claim 1, wherein the retention time is a time duration when the cursor stays still.

4. The real-time translation system with a multimedia display function according to claim 1, wherein the time condition is a time length allowing to record the cursor coordinates.

5. The real-time translation system with a multimedia display function according to claim 1, wherein the floating block is hidden or displayed by pressing a functional key.

6. The real-time translation system with a multimedia display function according to claim 1, wherein the floating block comprises an audio/video control row adapted to control display or play modes of the audio/visual data.

7. A real-time translation method with a multimedia display function, comprising:
establishing at least one translation vocabulary, wherein the translation vocabularies correspond to at least one audio/visual data respectively;
detecting continuously a retention time of a cursor, and recording cursor coordinates when the retention time meets a time condition requirement;
retrieving an input vocabulary according to the cursor coordinates;
comparing the input vocabulary with the translation vocabularies, and loading a translation vocabulary and a corresponding audio/visual data when the input vocabulary and the translation vocabulary are consistent with each other through comparison; and
displaying or playing the loaded translation vocabulary and the audio/visual data through a floating block.

8. The real-time translation method with a multimedia display function according to claim 7, wherein the audio/visual data comprises at least one selected from a group consisting of an image, a movie, and a sound.

9. The real-time translation method with a multimedia display function according to claim 7, wherein the retention time is a time duration when the cursor stays still.

10. The real-time translation method with a multimedia display function according to claim 7, wherein the time condition is a time length allowing to record the cursor coordinates.

11. The real-time translation method with a multimedia display function according to claim 7, wherein the floating block is hidden or displayed by pressing a functional key.

12. The real-time translation method with a multimedia display function according to claim 7, wherein the floating block comprises an audio/video control row adapted to control display or play modes of the audio/visual data.
